(19) United States
(12) Patent Application Publication
(10) Pub. No.: US 2023/0402047 A1
(43) Pub. Date: Dec. 14, 2023

(54) AUDIO PROCESSING METHOD AND APPARATUS, ELECTRONIC DEVICE, AND COMPUTER-READABLE STORAGE MEDIUM

(71) Applicant: Tencent Music Entertainment Technology (Shenzhen) Co., Ltd., Shenzhen (CN)

(72) Inventor: Dong Xu, Shenzhen (CN)

(73) Assignee: Tencent Music Entertainment Technology (Shenzhen) Co., Ltd., Shenzhen (CN)

(21) Appl. No.: 18/034,207

(22) PCT Filed: Sep. 22, 2021
(86) PCT No.: PCT/CN2021/119539

§ 371 Date: Apr. 27, 2023

(30) Foreign Application Priority Data
Oct. 28, 2020 (CN) 202011171384.5

(51) Int. Cl. G10L 21/003

(52) U.S. Cl. CPC G10L 21/003

(57) ABSTRACT

A method and apparatus for audio processing, an electronic device, and a computer-readable storage medium are provided in the present disclosure. The method includes: obtaining a target dry audio, and determining a beginning and ending time of each lyric word in the target dry audio; detecting a pitch of the target dry audio and a fundamental frequency during the beginning and ending time, and determining a current pitch name of the lyric word based on the fundamental frequency and the pitch; tuning up the lyric word by a first key interval to obtain a first harmony, and tuning up the lyric word by different second key intervals respectively to obtain different second harmonies; synthesizing the first harmony and the second harmonies to form a multi-track harmony; and mixing the multi-track harmony with the target dry audio to obtain a synthesized dry audio.

This application claims priority to Chinese Patent Application No. 202011171384.5, titled “AUDIO PROCESSING METHOD AND APPARATUS, ELECTRONIC DEVICE, AND COMPUTER-READABLE STORAGE MEDIUM”, filed on Oct. 28, 2020 with the China National Intellectual Property Administration, which is incorporated herein by reference in its entirety.

### FIELD

The present disclosure relates to the field of audio processing, and in particular to a method and apparatus for audio processing, an electronic device, and a computer-readable storage medium.

### BACKGROUND

In a singing scene, a conventional technology is to collect a dry audio directly from a user by using an audio collection device. Most users are blind to controls over vocal, oral, chest resonance, and other aspects due to lack of professional training for singing. Therefore, the dry audio recorded directly from the user has a poor auditory effect. Hence, a problem of the poor auditory effect of a dry audio has drawn an attention in a process of implementing the conventional technology.

Therefore, those skilled in the art are interested in a technical problem of how to improve an auditory effect of a dry audio.

### SUMMARY

An objective of the present disclosure is to provide a method and an apparatus for audio processing, an electronic device, and a computer-readable storage medium, which can improve an auditory effect of a dry audio.

To achieve the above objective, a method for audio processing is provided according to a first aspect of the present disclosure. The method includes: obtaining a target dry audio, and determining a beginning and ending time of each lyric word in the target dry audio; detecting a pitch of the target dry audio and a fundamental frequency during the beginning and ending time, and determining a current pitch name of the lyric word based on the fundamental frequency and the pitch; tuning up the lyric word by a first key interval to obtain a first harmony, and tuning up the lyric word by different second key intervals respectively to obtain different second harmonies, where the first key interval indicates a positive integer number of keys, each of the second key intervals is a sum of the first key interval and a third key interval, and different ones of the second key intervals are determined from different third key intervals, and the first key interval is different form the third key interval by one order of magnitude; synthesizing the first harmony and the second harmonies to form a multi-track harmony; and mixing the multi-track harmony with the target dry audio to obtain a synthesized dry audio.

To achieve the above objective, an apparatus for audio processing is provided in a second aspect of the present disclosure. The apparatus includes: an obtaining module, configured to obtain a target dry audio, and determine a beginning and ending time of each lyric word in the target dry audio; a detection module, configured to detect a pitch of the target dry audio and a fundamental frequency during the beginning and ending time, and determine a pitch name of the lyric word based on the fundamental frequency and the pitch; a tuning-up module, configured to tune up the lyric word by a first key interval to obtain a first harmony, and tune up the lyric word by different second key intervals respectively to obtain different second harmonies, where the first key interval indicates a positive integer number of keys, each of the second key intervals is a sum of the first key interval and a third key interval, and different ones of the second key intervals are determined from different third key intervals, and the first key interval is different form the third key interval by one order of magnitude; a synthesis module, configured to synthesize the first harmony and the second harmonies to form a multi-track harmony; and a mixing module, configured to mix the multi-track harmony with the target dry audio to obtain a synthesized dry audio.

To achieve the above objective, an electronic device is provided in a third aspect of the present disclosure. The electronic device includes: a memory storing a computer program; and a processor, where the processor, when executing the computer program, is configured to perform the method for audio processing.

In order to achieve the above objective, a computer-readable storage medium is provided in a fourth aspect of the present disclosure. The computer-readable storage medium stores a computer program, and the computer program, when executed by a processor, implements the method for audio processing.

From the above, it can be seen that the method for audio processing provided in the present disclosure includes: obtaining a target dry audio, and determining a beginning and ending time of each lyric word in the target dry audio; detecting a pitch of the target dry audio and a fundamental frequency during the beginning and ending time, and determining a current pitch name of the lyric word based on the fundamental frequency and the pitch; tuning up the lyric word by a first key interval to obtain a first harmony, and tuning up the lyric word by different second key intervals respectively to obtain different second harmonies, where the first key interval indicates a positive integer number of keys, each of the second key intervals is a sum of the first key interval and a third key interval, and different ones of the second key intervals are determined from different third key intervals, and the first key interval is different form the third key interval by one order of magnitude; and synthesizing the first harmony and the second harmonies to form a multi-track harmony; and mixing the multi-track harmony with the target dry audio to obtain a synthesized dry audio.

In the method for audio processing provided in the present disclosure, the target dry audio inputted from the user is tuned up by the first key interval indicating a positive integer number of keys based on a chord music theory, so that the first harmony obtained after tuning up is more musical and more in line with listening habits of the human ear. The multiple different second harmonies are generated through perturbation. The multi-track harmony formed from the first harmony and the second harmonies realizes a simulation of a real-world scene where a singer sings and records multiple times, avoiding an auditory effect of a thin single-track harmony. The multi-track harmony is mixed with the target dry audio to obtain the synthesized dry audio which is more suitable for human hearing, so that a layering of the dry audio is enhanced. Therefore, it can be seen that the method for audio processing according to the embodiments of the present disclosure can realize improvement of an auditory effect of a dry audio. The apparatus for audio processing, the electronic device, and the computer-readable storage medium disclosed in the present disclosure have the same technical effects as described above.

It should be understood that the general description above and the detailed description below are merely illustrative, and do not limit the present disclosure.

### BRIEF DESCRIPTION OF THE DRAWINGS

In order to more clearly illustrate the technical solutions in the embodiments according to the present disclosure or in the conventional technology, the accompanying drawings used in the description of the embodiments or the conventional technology are briefly described hereinafter. Apparently, the accompanying drawings in the following description are only some embodiments of the present disclosure. Other accompanying drawings may be obtained by those skilled in the art from these accompanying drawings, without any creative effort. The accompanying drawings are intended to provide a further understanding of the present disclosure and form a part of the specification, and are used to explain the present disclosure together with the following specific embodiments, but do not limit the present disclosure. In the accompanying drawings:

FIG. 1 is an architecture diagram of a system for audio processing according to an embodiment of the present disclosure;

FIG. 2 is a flowchart of a method for audio processing according to a first embodiment of the present disclosure;

FIG. 3 is a flowchart of a method for audio processing according to a second embodiment of the present disclosure;

FIG. 4 is a flowchart of a method for audio processing according to a third embodiment of the present disclosure;

FIG. 5 is a flowchart of a method for audio processing according to a fourth embodiment of the present disclosure;

FIG. 6 is a structural diagram of an apparatus for audio processing according to an embodiment of the present disclosure; and

FIG. 7 is a structural diagram of an electronic device according to an embodiment of the present disclosure.

### DETAILED DESCRIPTION

The technical solutions in the embodiments of the present disclosure are clearly and completely described hereinafter in connection with the accompanying drawings in the embodiments of the present disclosure. Apparently, the described embodiments are only a part of, rather than all, the embodiments of the present disclosure. All other embodiments obtained by those of ordinary skills in the art from the embodiments of the present disclosure without any creative effort fall within the protection scope of the present disclosure.

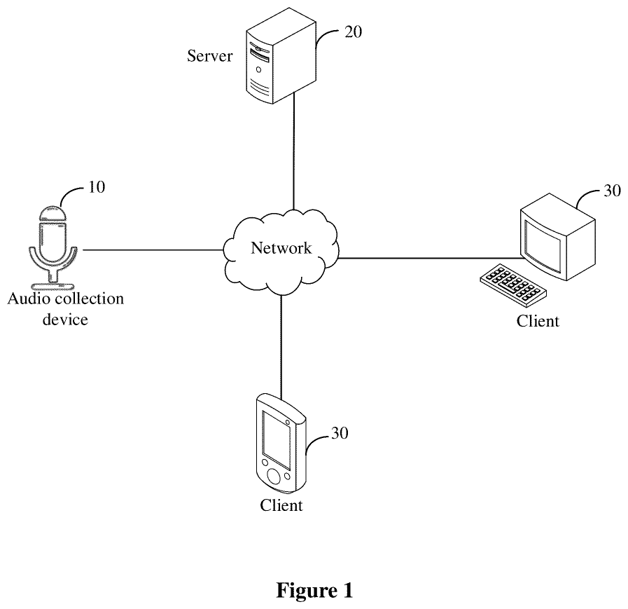

For ease of understanding of the method for audio processing provided in the present disclosure, a system to which the method is applied is illustrated below. Reference is made to FIG. 1, which shows an architecture diagram of a system for audio processing according to an embodiment of the present disclosure. As shown in FIG. 1, the system includes an audio collection device 10 and a server 20.

The audio collection device 10 is configured to collect a target dry audio recorded from a user. The server 20 is configured to tune up the target dry audio to obtain a multi-track harmony, and mix the multi-track harmony with target dry audio to obtain a synthesized dry audio which is more suitable for human hearing.

The system for audio processing may further include a client 30. The client 30 may include a fixed terminal such as a personal computer (PC) and a mobile terminal such as a mobile phone. The client 30 may be equipped a speaker for outputting the synthesized dry audio or a song synthesized based on the synthesized dry audio.

A method for audio processing is provided according to an embodiment of the present disclosure, which can improve an auditory effect of a dry audio.

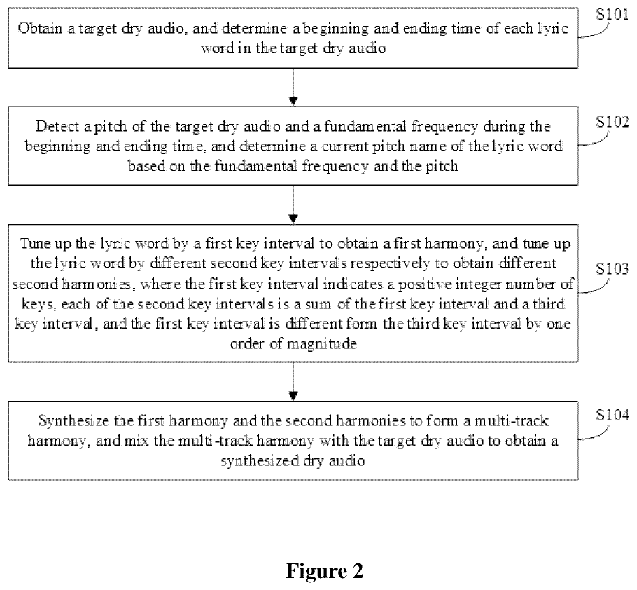

Reference is made to FIG. 2, which is a flowchart of a method for audio processing according to a first embodiment of the present disclosure. As shown in FIG. 2, the method includes steps S101 to S104 as below.

In S101, a target dry audio is obtained, and a beginning and ending time of a lyric word in target dry audio is determined.

An executive subject for the embodiment is the server in the system for audio processing as in the previous embodiment, with an aim of processing the target dry audio recorded from a user to obtain a synthesized dry audio which is more suitable for human hearing. In this step, an audio collection device collects the target dry audio recorded from the user and transmits the target dry audio to a server. It should be noted that the target dry audio is a waveform file of a dry sound from the user. An audio format of the target dry audio is not limited here, and may include an MP3, a WAV (Waveform Audio File Format), a FLAC (Free Lossless Audio Codec), an OGG (OGG Vorbis), and other formats. In a preferable embodiment, a lossless encoding format, such as the FLAC and WAV, may be adopted to ensure lossless of sound information.

In a specific implementation, the server first obtains a lyrics text corresponding to the target dry audio. The lyric text corresponding to the target dry audio may be obtained directly, or extracted directly from the target dry audio, that is, by identifying the lyrics text corresponding to a dry sound in the dry audio, which is not specifically limited here. It can be understood that the target dry audio recorded from the user may include a noise, which may result in inaccurate identification of lyrics. Therefore, a noise reduction may be performed on a training dry audio before recognizing the lyrics text.

Each lyric word in the target dry audio is obtained from the lyrics text. It can be understood that lyrics are generally stored in a form of lyric words and beginning and ending times of the lyric words. For example, a section of a lyrics text is represented as: Tai [0,1000] Yang [1000,1500] Dang [1500,3000] Kong [3000,3300] Zhao [3300,5000], where content in the parentheses represents a beginning and ending time of a lyric word, in a unit of millisecond. That is, the “Tai” begins at 0 millisecond and ends at a 1000th millisecond; the “Yang” begins at the 1000th millisecond, and ends at a 1500th millisecond; and the like. The extracted lyrics text is “Tai, Yang, Dang, Kong, Zhao”. The lyrics may be in another language. For example, the extracted lyrics text is “the, sun, is, rising”, in English. Phonetic symbols of the lyric words are determined based on a text type of each lyric word. In a case that the text type of the lyric word is Chinese characters, the phonetic symbols corresponding to the lyric word is Chinese Pinyin. For example, the Chinese lyrics text “Tai, Yang, Dang, Kong, Zhao” corresponds to phonetic symbols “tai yang dang kong zhao”, and an English lyrics text corresponds to English phonetic symbols.

In S102, a pitch of the target dry audio and a fundamental frequency within the beginning and ending time are detected, and a current pitch name of the lyric word is determined based on the fundamental frequency and the pitch.

In this step, the pitch of the inputted target dry audio is detected, and the fundamental frequency during the beginning and ending time is determined. The current pitch name of the lyric word is determined by analyzing the fundamental frequency of a sound during the beginning and ending time of the lyric word, in combination with the pitch. For example, for a lyric word “you” during a time period (t1, t2), a pitch name of the lyric word can be obtained by extracting a fundamental frequency of a sound during the time period (t1, t2), on a basis that a pitch of a dry sound is obtained.

In S103, the lyric word is pitched up by a first key interval to obtain a first harmony, and the lyric word is pitched up by different second key intervals to obtain different second harmonies. The first key interval indicates a positive integer number of keys, each of the second key intervals is a sum of the first key interval and a third key interval, and different ones of the second key intervals are determined from different third key intervals, and the first key interval is different form the third key interval by one order of magnitude.

A purpose of this step is to tune up the target dry audio to better match human hearing. In a specific implementation, each lyric word in the target dry audio is tuned up by the first key interval and the different second key intervals to obtain the first harmony and different second harmonies, respectively. The first key interval indicates a positive integer number of keys. A key interval represents a key difference between a target key after a tuning up process and a current key. The first harmony is equivalent to a chord tuning-up of the target dry audio. Each of the second key intervals is a sum of the first key interval and a third key interval, and different ones of the second key intervals are determined from different third key intervals. The third key interval is less than the first key interval by one order of magnitude, that is, the second harmony is equivalent to a fine-tuning of the first harmony.

It can be understood that those skilled in the art may directly set values of the first key interval and the different third key intervals. Alternatively, a pitch name interval and the different third key intervals may be preset, and a program determines the first key interval based on the preset pitch name interval and music theories of major triad and minor triad. That is, a process of tuning up the lyric word by the first key interval to obtain a first harmony, and tuning up the lyric word by different second key intervals to obtain different second harmonies includes: determining a preset pitch name interval, and tuning up the lyric word by the preset pitch name interval to obtain the first harmony, where adjacent pitch names are different from each other by one or two first key intervals; and tuning up the first harmony by the third key intervals respectively to obtain the second harmonies. In a specific implementation, each lyric word in the target dry audio is tuned up by the preset pitch name interval to obtain the first harmony, and each lyric word in the target dry audio is tuned up by the multiple different third key intervals respectively to obtain multiple different second harmonies. It can be understood that the preset pitch name interval indicates a difference between a target pitch name after a tuning-up process and a current pitch name. The pitch name (which is a name defined for a fixed height of pitch) may include CDEFGAB. A process of tuning up by seven pitch names is equivalent to tuning up by 12 keys. A process of tuning up by 12 keys is equivalent to that a frequency is doubled, for example, the frequency is changed from 440 Hz to 880 Hz. A process of tuning up by 3 keys is equivalent to increasing a frequency to a 3/12 power of 2 (approximately 1.189 times), for example, the frequency is changed from 440 Hz to 523 Hz. The preset pitch name interval is not specifically limited here, and can be determined by those skilled in the art based on an actual situation. Generally, the preset pitch name interval is less than or equal to 7, and is 2 preferably. According to the music theories of major triad and minor triad, a key interval between adjacent pitch names may be one or two keys. Reference can be made to Table 1, where “+key” indicates the key interval between adjacent pitch names.

TABLE 1

| Pitch name | C | D | E | F | G | A | B | C |
|---|---|---|---|---|---|---|---|---|
| Syllable name | do | re | mi | fa | so | la | si | Do |
| Numbered notation | 1 | 2 | 3 | 4 | 5 | 6 | 7 | 1 |
| +key | | +2 | +2 | +1 | +2 | +2 | +2 | +1 |

In an implementation, a process of tuning up a lyric word by the preset pitch name interval to obtain the first harmony includes: determining, based on a current pitch name and the preset pitch name interval, a target pitch name of the lyric word after tuned up by the preset pitch name interval; determining a quantity of the first key intervals corresponding to the lyric word based on a key interval between the target pitch name of the lyric word and the current pitch name of the lyric word; and tuning up the lyric word by the quantity of the first key intervals to obtain the first harmony.

In a specific implementation, the quantity of the first key intervals by which the lyric word is to be tuned up may be determined based on the key interval between the target pitch name and the current pitch name of the lyric word, and the lyric word is tuned up by the quantity of the first key intervals to obtain the first harmony. A preset pitch name interval of 2 is taken as an example below. In a case that a lyric word “you” within a time period (t1, t2) has a current pitch name C, it can be known from Table 1 that a corresponding syllable name is do, a corresponding numbered notation is 1. The target pitch name of the lyric word “you” after tuned up by 2 pitch names is E, and a key difference between the target pitch name and the current pitch name (the first key interval) is 4, which means that the tune is raised by 4 keys, including 2 keys from C to D and 2 keys from D to E. In a case that a current pitch name of another lyric word is E, then a target pitch name after tuned up by 2 pitch names is G, and the first key interval between the target pitch name and the current pitch name is 3, that is, the tune is raised by 3 keys, including 1 key from E to F and 2 keys from F to G. The mentioned tuning up process is based on the music theories of major triad and minor triad, which enables a sound after tuned up more musical and more in line with listening habits of the human ear.

Each lyric word is tuned up correspondingly through the above method, so that the target dry audio is tuned up, which is referred to as the first harmony after chord tuning-up, and is a single-track harmony. It can be understood that the tuning up process in the embodiment is to increase a fundamental frequency of a sound to obtain a sound having a raised pitch in hearing.

The single-track harmony is slightly tuned, that is, tuned up by third key intervals to obtain a multi-track harmony. The third key intervals are not specifically limited here, and can be determined flexibly by those skilled in the art based on an actual situation. Generally, a third key interval does not exceed 1 key. The different second harmonies have different preset key intervals relative to the first harmony, for example, the preset key intervals may be 0.1key, 0.15key, 0.2key, and the like. The quantity of tracks of the second harmonies is not limited here, and may be 3 tracks, 5 tracks, 7 tracks, and the like, corresponding to 3 preset key intervals, 5 preset key intervals, and 7 preset key intervals, respectively.

A slight tuning of the single-track harmony is actually a simulation of a real-world scene where a singer sings and records multiple times. In a case that a same song is sung and recorded multiple times, it is difficult to ensure a same pitch in every singing, that is, a slight fluctuation in pitch may occur. Such fluctuation brings a richer feeling of mixing and avoids a thin effect. Hence, the multi-track harmony can enhance a layering of the dry audio.

In S104, the first harmony and the second harmonies are synthesized to form a multi-track harmony, and the multi-track harmony is mixed with the target dry audio to obtain a synthesized dry audio.

In this step, the first harmony and the second harmonies obtained from the previous step are synthesized to obtain the multi-track harmony, and the multi-track harmony is mixed with the target dry audio to obtain the synthesized dry audio. In an implementation, a process of synthesizing the first harmony and the second harmonies to form a multi-track harmony includes: determining volumes and delays of the first harmony and the second harmonies, respectively; mixing the first harmony and the second harmonies based on the volumes and delays to obtain the synthesized dry audio. In a specific implementation, a volume and a delay of each track for mixing are first determined. Given the volume represented by a and a delay represented by delay, an i-th harmony SHᵢ after processing may be expressed as y=a×SHᵢ+delay. In the expression, a is generally equal to 0.2, or may be another value; and the delay is generally equal to 1 and 30, in a unit of milliseconds, or may be another value. The harmonies are superimposed based on volumes and delays to obtain the synthesized dry audio. A formula is expressed as:

$$Harmony = {{\sum }_{i}}^{m} ( {a}_{i} \times {SH}_{i} + {delay}_{i} ) ,$$

where a, represents a volume coefficient of an i-th harmony, SHᵢ represents the i-th harmony, delayᵢ represents a delay coefficient of the i-th harmony, and m represents a total number of tracks of the multi-track harmony.

In the method for audio processing according to the embodiments of the present disclosure, the target dry audio inputted from the user is tuned up by the first key interval indicating a positive integer number of keys based on a chord music theory, so that the first harmony obtained after tuning up is more musical and more in line with listening habits of the human ear. The multiple different second harmonies are generated through perturbation. The multi-track harmony formed from the first harmony and the second harmonies realizes a simulation of a real-world scene where a singer sings and records multiple times, avoiding an auditory effect of a thin single-track harmony. The multi-track harmony is mixed with the target dry audio to obtain the synthesized dry audio which is more suitable for human hearing, so that a layering of the dry audio is enhanced. Therefore, it can be seen that the method for audio processing according to the embodiments of the present disclosure can realize improvement of an auditory effect of a dry audio.

In a preferred embodiment on the basis of the above embodiments, after mixing the multi-track harmony with the target dry audio to obtain a synthesized dry audio, the method further includes: adding a sound effect to the synthesized dry audio by using a sound effect device; and obtaining an accompaniment audio corresponding to the synthesized dry audio, and superimposing the accompaniment audio with the synthesized dry audio added with the sound effect in a preset manner to obtain a synthesized audio.

It can be understood that the synthesized target dry audio may be combined with an accompaniment to generate a final song. The synthesized song may be stored in a background of a server, outputted to a client, or played through a speaker.

In a specific implementation, the synthesized target dry audio may be processed by using a reverberator, an equalizer, and other sound effect devices, to obtain a dry audio with a sound effect. The sound effect devices may be applied in many ways, such as by a sound plugin, a sound effect algorithm, and other processing, which are not specifically limited here. The target dry audio is a pure human voice audio without a sound of an instrument, which is actually different from a usual song in daily life. For example, the target dry audio does not include a prelude without a human voice. In a case that there is no accompaniment, the prelude is silent. Therefore, it is necessary to superimpose the accompaniment audio with the target dry audio added with the sound effect in a preset manner to obtain the synthesized audio, that is, a song.

A specific method for superimposing is not limited here, and may be determined flexibly by those skilled in the art based on an actual situation. In an implementation, a process of superimposing the accompaniment audio with the synthesized dry audio added with the sound effect in a preset manner to obtain a synthesized audio includes: performing a power normalization on the accompaniment audio to obtain an intermediate accompaniment audio, and performing a power normalization on the synthesized dry audio added with the sound effect to obtain an intermediate dry audio; and superimposing, based on a preset energy ratio, the intermediate accompaniment audio with the intermediate dry audio, to obtain the synthesized audio. In a specific implementation, a power normalization is performed on the accompaniment audio and the target dry audio added with the sound effect, obtaining the intermediate accompaniment audio accom and the intermediate dry audio vocal, both of which are time waveforms. Assuming a preset energy ratio of 0.6:0.4, the synthesized audio W is calculated as W=0.6×vocal+0.4×accom.

As can be seen from this embodiment, an original dry sound released by a user is processed utilizing the efficiency, robustness, and accuracy of an algorithm to obtain the harmonies. The harmonies are mixed with the original dry sound to obtain a processed song, which brings a more pleasant listening experience, that is, a music appeal of the published work form the user is enhanced. Thereby, it is conducive to improving user satisfaction. In addition, it is conductive to enhancing an influence and competitiveness of a content provider on a singing platform.

A method for audio processing is further provided according to an embodiment of the present disclosure. Compared with the previous embodiment, the technical solution is further explained and optimized in this embodiment.

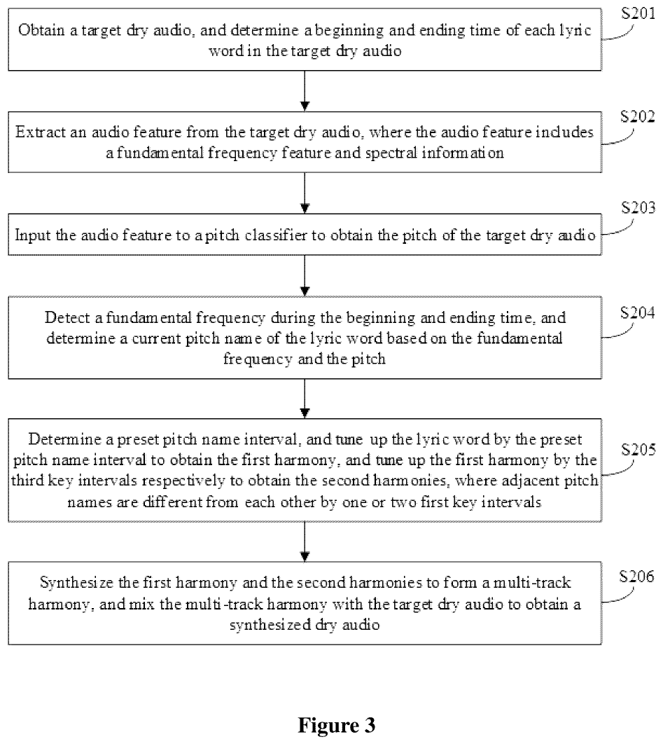

Reference is made to FIG. 3, which is a flowchart of a method for audio processing according a second embodiment of the present disclosure. As shown in FIG. 3, the method includes steps S201 to S206 as follows.

In S201, a target dry audio is obtained, and a beginning and ending time of each lyric word in the target dry audio is determined.

In S202, an audio feature is extracted from the target dry audio, where the audio feature includes a fundamental frequency feature and spectral information.

This step is to extract the audio feature for training the dry audio. The audio feature is closely related to a vocal characteristic and sound quality of the target dry audio. The audio feature here may include a fundamental frequency feature and spectral information. The fundamental frequency feature refers to a lowest vibration frequency of a dry audio segment, which reflects a pitch of the dry audio. A larger value of the fundamental frequency indicates higher pitch of the dry audio. The spectrum information refers to a distribution curve of a frequency of the target dry audio.

In S203, the audio feature is inputted into a pitch classifier to obtain the pitch of the target dry audio.

In this step, the audio feature is inputted into the pitch classifier to obtain the pitch of the target dry audio. The pitch classifier here may include a Hidden Markov Model (HMM), a support Vector Machine (SVM), a deep learning model, and the like, which is not specifically limited here.

In S204, a fundamental frequency during the beginning and ending time is detected, and a current pitch name of the lyric word is determined based on the fundamental frequency and the pitch.

In S205, a preset pitch name interval is determined, the lyric word is tuned up by the preset pitch name interval to obtain a first harmony, and the first harmony is tuned up by the third key intervals respectively to obtain the second harmonies, where adjacent pitch names are different from each other by one or two first key intervals.

In S206, the first harmony and the second harmonies are synthesized to form a multi-track harmony, and the multi-track harmony is mixed with the target dry audio to obtain a synthesized dry audio.

It can be seen from this embodiment that the audio feature of the target dry audio is inputted to the pitch classifier to obtain the pitch up of the target dry audio, so that the pitch is detected more accurately.

A method for audio processing is further provided according to an embodiment of the present disclosure. Compared with the first embodiment, the technical solution is further explained and optimized in this embodiment.

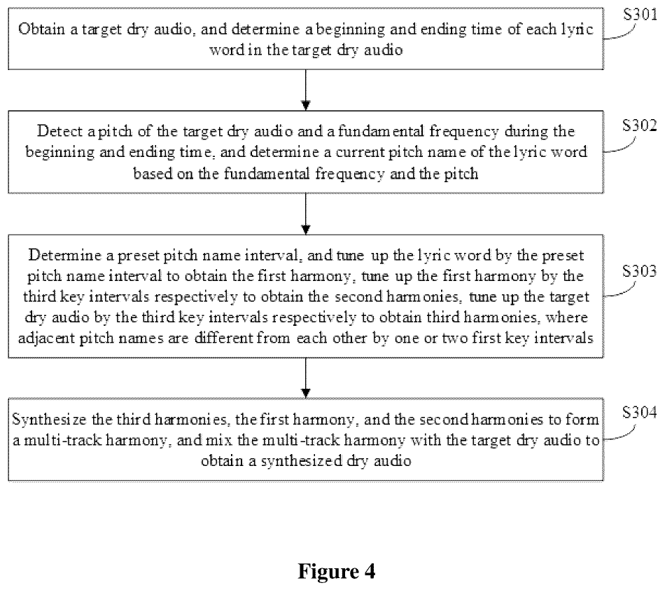

Reference is made to FIG. 4, which is a flowchart of a method for audio processing according to a third embodiment of the present disclosure. As shown in FIG. 4, the method includes steps S301 to S304 as follows.

In S301, a target dry audio is obtained, and a beginning and ending time of each lyric word in the target dry audio is determined.

In S302, a pitch of the target dry audio and a fundamental frequency during the beginning and ending time are detected, and a current pitch name of the lyric word is determined based on the fundamental frequency and the pitch.

In S303, a preset pitch name interval is determined, the lyric word is tuned up by the preset pitch name interval to obtain a first harmony, the first harmony is tuned up by the third key intervals respectively to obtain the second harmonies, the target dry audio is tuned up by the third key intervals respectively to obtain third harmonies, where adjacent pitch names are different from each other by one or two first key intervals.

In S304, the third harmonies, the first harmony, and the second harmonies are synthesized to form a multi-track harmony, and the multi-track harmony is mixed with the target dry audio to obtain a synthesized dry audio.

In this embodiment, in order to realize singing characteristics of different users, the target dry audio may be slightly tuned up, that is, each lyric word in the target dry audio is tuned up by a preset key interval, to obtain a third harmony. The third harmony is added to the multi-track harmony. By obtaining the harmonies based on tuning up of a dry sound, the harmonies can bring a better listening effect to an original dry sound from a user, so that a quality of a published work is improved.

In an implementation, a process of synthesizing the third harmonies, the first harmony, and the second harmonies to form a multi-track harmony includes: determining volumes and delays of the third harmonies, the first harmony, and the second harmonies, respectively; and synthesizing the third harmonies, the first harmony, and the second harmonies based on the volumes and delays to obtain the multi-track harmony. This process is similar to the process described in the first embodiment, and is not repeated here.

As can be seen from this embodiment, the dry sound from the user is processed to obtain a single-track harmony which conforms to a chord, and a multi-track harmony having improved layering and richness. The harmonies are mixed together to form a mixed single-track harmony. The mixed single-track harmony is superimposed with the dry sound to obtain a processed vocal, which sounds more pleasant than the original dry vocal. Hence, a quality of a work of the user is improved, and user satisfaction is improved.

A method for audio processing is further provided according to an embodiment of present disclosure. Compared to the first embodiment, the technical solution is further described and optimized in this embodiment.

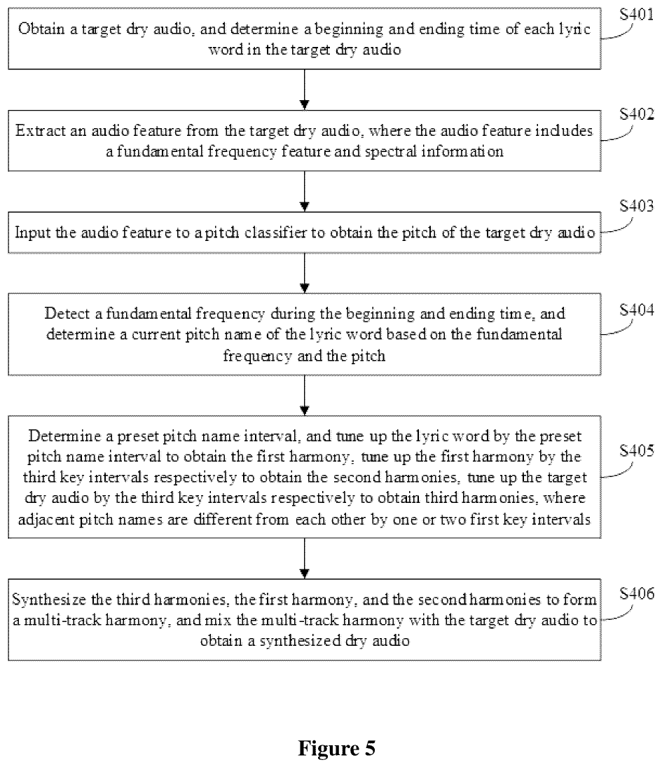

Reference is made to FIG. 5, which is a flowchart of a method for audio processing according to a fifth embodiment of the present disclosure. As shown in FIG. 5, the method includes step S401 to S406 as follows.

In S401, a target dry audio is obtained, and a beginning and ending time of each lyric word in the target dry audio is determined.

In S402, an audio feature is extracted from the target dry audio, where the audio feature includes a fundamental frequency feature and spectral information.

In S403, the audio feature is inputted to a pitch classifier to obtain a pitch of the target dry audio.

In S404, a fundamental frequency during the beginning and ending time is detected, and a current pitch name of the lyric word is determined based on the fundamental frequency and the pitch.

In S405, a preset pitch name interval is determined, the lyric word is tuned up by the preset pitch name interval to obtain the first harmony, the first harmony is tuned up by the third key intervals respectively to obtain the second harmonies, the target dry audio is tuned up by the third key intervals respectively to obtain third harmonies, where adjacent pitch names are different from each other by one or two first key intervals.

In S406, the third harmonies, the first harmony, and the second harmonies are synthesized to form a multi-track harmony, and the multi-track harmony is mixed with the target dry audio to obtain a synthesized dry audio.

As can be seen from the embodiment, the audio feature of the target dry audio is inputted to the pitch classifier to obtain the pitch of the target dry audio, so that the pitch can be detected more accurately. The dry sound recorded from the user is processed so that a multi-track harmony having improved layering and richness is obtained. The mixed single-track harmony is obtained through mixing, which enhances the layering of the dry audio, so that the dry audio sounds more pleasant and presents an improving auditory effect. In addition, this embodiment can be processed through a computer backend or cloud, which has a high processing efficiency and high running speed.

For ease of understanding, description is made in conjunction with an application scenario of the present disclosure. Reference is made to FIG. 1. In a karaoke scenario, a user records a dry audio by using an audio collection device of a karaoke client, and a server performs audio processing on the dry audio. There may be the following steps.

Step 1: Chord Tuning-Up

In this step, a pitch of an inputted dry audio is detected first. Then, a beginning and ending time of each lyric word is obtained through a lyric duration. A fundamental frequency of sound during the beginning and ending time is analyzed to obtain a pitch of the lyric word in the beginning and ending time. Finally, the sound during the beginning and ending time is tuned up based on music theories of major triad and minor triad. Each lyric word is tuned up correspondingly to obtain a tuned-up result of the dry sound, which is a harmony after chord tuning-up. A method to tune up is to increase the fundamental frequency of a sound, so as to obtain a sound having an increased pitch on auditory feeling. Such harmony has only one track, and is referred to as a single-track harmony, denoted as harmony B.

Step 2: Tuning by Perturbation

In this step, the dry sound tuned-up by+0.1key, obtaining a harmony A. Then, the harmony B is tuned up by +0.1key, +0.15key, and +0.2key, respectively, to obtain a harmony C, a harmony D, and a harmony E. Finally, these harmonies are integrated together and noted as a 5-track harmony SH=[A, B, C, D, E].

Step 3: Multi-Track Mixing

In this step, volumes and delays of the tracks in mixing are determined, and then the tracks are superimposed based on the volumes and delays to obtain a mixed single-track harmony.

Step 4: Adding of Accompaniment and Reverb to Obtain a Processed Song

Step 5: Outputting

In this step, the processed song is outputted, for example, to a mobile terminal, backend storage, or played through a terminal speaker.

Hereinafter an apparatus for audio processing according to an embodiment of the present disclosure is described. The apparatus described below and the method for audio processing described above can refer to each other.

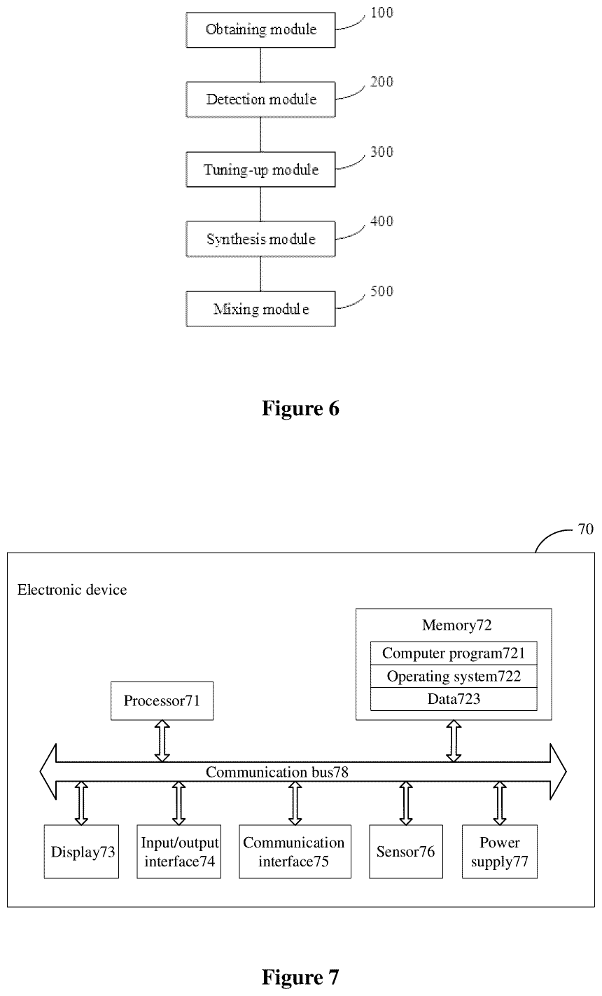

Reference is made to FIG. 6, which is a structural diagram of an apparatus for audio processing according to an embodiment of the present disclosure. As shown in FIG. 6, the apparatus includes an obtaining module 100, a detection module 200, a tuning-up module 300, a synthesis module 400, and a mixing module 500.

The obtaining module 100 is configured to obtain a target dry audio and determine a beginning and ending time of each lyric word in the target dry audio.

The detection module 200 is configured to detect a pitch of the target dry audio and a fundamental frequency during the beginning and ending time, and determine a pitch name of the lyric word based on the fundamental frequency and the pitch.

The tuning-up module 300 is configured to tune up the lyric word by a first key interval to obtain a first harmony, and tune up the lyric word by different second key intervals respectively to obtain different second harmonies. The first key interval indicates a positive integer number of keys, each of the second key intervals is a sum of the first key interval and a third key interval, and different ones of the second key intervals are determined from different third key intervals, and the first key interval is different from the third key interval by one order of magnitude;

The synthesis module 400 is configured to synthesize the first harmony and the second harmonies to form a multi-track harmony.

The mixing module 500 is configured to mix the multi-track harmony with the target dry audio to obtain a synthesized dry audio.

With the apparatus for audio processing provided in the embodiment of the present disclosure, the target dry audio inputted from the user is tuned up by the first key interval indicating a positive integer number of keys based on a chord music theory, so that the first harmony obtained after tuning up is more musical and more in line with listening habits of the human ear. The multiple different second harmonies are generated through perturbation. The multi-track harmony formed from the first harmony and the second harmonies realizes a simulation of a real-world scene where a singer sings and records multiple times, avoiding an auditory effect of a thin single-track harmony. The multi-track harmony is mixed with the target dry audio to obtain the synthesized dry audio which is more suitable for human hearing, so that a layering of the dry audio is enhanced. Therefore, it can be seen that the method for audio processing according to the embodiments of the present disclosure can realize improvement of an auditory effect of a dry audio.

In a preferred embodiment on the basis of the above embodiment, the detection module 200 includes an extraction unit, an input unit, and a first determination unit.

The extraction unit is configured to extract an audio feature from the target dry audio, where the audio feature includes a fundamental frequency feature and spectral information.

The input unit is configured to input the audio feature to a pitch classifier to obtain the pitch of the target dry audio.

The first determination unit is configured to detect a fundamental frequency during the beginning and ending time, and determine a current pitch name of the lyric word based on the fundamental frequency and the pitch.

In a preferred embodiment on the basis of the above embodiment, the tuning-up module 300 is specifically configured to tune up the lyric word by a preset pitch name interval to obtain a first harmony, tune up the first harmony by preset key intervals respectively to obtain second harmonies, and tune up the target dry audio by the third key intervals respectively to obtain third harmonies.

Correspondingly, the synthesis module 400 is specifically configured to: synthesize the third harmonies, the first harmony, and the second harmonies to form a multi-track harmony, and mix the multi-track harmony with the target dry audio to obtain a synthesized dry audio.

In a preferred embodiment on the basis of the above embodiment, the synthesis module 400 includes a second determination unit, a synthesis unit, and a mixing unit.

The second determination unit is configured to determine volumes and delays corresponding to the third harmonies, the first harmony, and the second harmonies, respectively.

The synthesis unit is configured to synthesize the third harmonies, the first harmony, and the second harmonies based on the volumes and delays to form a multi-track harmony.

The mixing unit is configured to mix the multi-track harmony with the target dry audio to obtain a synthesized dry audio.

In a preferred embodiment on the basis of the above embodiment, the apparatus further includes an adding module and a superimposing module.

The adding module is configured to add a sound effect to the synthesized dry audio by using a sound effect device.

The superimposing module is configured to obtain an accompaniment audio corresponding to the synthesized dry audio, and superimpose the accompaniment audio with the synthesized dry audio added with the sound effect in a preset manner to obtain a synthesized audio.

In a preferred embodiment on the basis of the above embodiment, the superimposing module includes an obtaining unit, a normalization unit, and a superimposing unit.

The obtaining unit is configured to obtain an accompaniment audio corresponding to the synthesized dry audio.

The normalization processing unit is configured to perform a power normalization on the accompaniment audio and the synthesized dry audio added with the sound effect, to obtain an intermediate accompaniment audio and an intermediate dry audio, respectively;

The superimposing unit is configured to superimpose the intermediate accompaniment audio and the intermediate dry audio based on a preset energy ratio to obtain the synthesized audio.

In a preferred embodiment on the basis of the above embodiment, the tuning-up module 300 includes a first tuning-up unit and a second tuning-up unit.

The first tuning-up unit is configured to determine a preset pitch name interval, and tune up the lyric word by a preset key interval to obtain a first harmony, where adjacent pitch names are different from each other by one or two first key intervals.

The second tuning-up unit is configured to perform the third key intervals on the first harmony respectively to obtain different second harmonies.

In a preferred embodiment on the basis of the above embodiment, the first tuning-up unit includes a first determining sub-unit, a second determining sub-unit, and a tuning-up sub-unit.

The first determining subunit is configured to determine a preset pitch name interval, and determine, based on the current pitch name and the preset pitch name interval, a target pitch name of the lyric word after tuned up by the preset pitch name interval.

The second determining subunit is configured to determine a quantity of the first key intervals corresponding to the lyric word based on a key interval between the target pitch name of the lyric word and the current pitch name of the lyric word.

The tuning-up sub-unit is configured to tune up the lyric word by the quantity of the first key intervals to obtain the first harmony.

Specific operations of modules in the apparatus according to the above embodiments are described in detail in the embodiments related to the method, and are not described in detail here.

An electronic device is further provided in the present disclosure. Reference is made to FIG. 7, which is a structural diagram of an electronic device 70 according to an embodiment of the present disclosure. As shown in FIG. 7, the electronic device 70 may include a processor 71 and a memory 72.

The processor 71 may include one or more processing cores. For example, the processor may be a 4-core processor, an 8-core processor, or the like. The processor 71 may be implemented in at least one hardware form of a DSP (Digital Signal Processing), an FPGA (Field Programmable Gate Array), or a PLA (Programmable Logic Array). The processor 71 may further include a main processor and a coprocessor. The main processor is to process data in a wake-up state, and is also known as a central processing unit (CPU). The coprocessor is a low-power processor for processing data in standby mode. In some embodiments, the processor 71 may be integrated with a graphics processing unit (GPU). The GPU is for rendering and drawing a content required to be displayed on a display screen. In some embodiments, the processor 71 may further include an artificial intelligence (AI) processor for processing computations related to machine learning.

The memory 72 may include at least one computer-readable storage medium. The computer-readable storage medium may be non-transient. The memory 72 may further include a high-speed random access memory and a non-volatile memory, such as a disk storage device, and a flash memory storage device. In an embodiment, the memory 72 is at least configured to store a computer program 721. The computer program 721, when loaded and executed by the processor 71, can implement related steps to be executed on a server side in the method for audio processing disclosed in any of the aforementioned embodiments. In addition, resources stored in the memory 72 may further include an operating system 722, data 723, and the like, which may be stored temporarily or permanently. The operating system 722 may include Windows, Unix, Linux, and the like.

In some embodiments, the electronic device 70 may further include a display screen 73, an input/output interface 74, a communication interface 75, a sensor 76, a power supply 77, and a communication bus 78.

The structure of the electronic device shown in FIG. 7 does not constitute a limitation on the electronic device provided in the embodiments of the present disclosure. In practical applications, the electronic device may include more or fewer components than those shown in FIG. 7, or a combination of certain components.

A computer-readable storage medium including program instructions is further provided in an embodiment. The program instructions, when executed by a processor, cause the processor to execute the method for audio processing in any of the above embodiments.

Herein the embodiments are described in a progressive manner. Each of the embodiments focuses on differences with other embodiments, and the same and similar parts of the embodiments can be referred to each other. Description of the apparatus disclosed in the embodiments is simple, as the apparatus corresponds to the method disclosed in the embodiments. Reference may be made to corresponding description of the method for details of the apparatus. It should be noted that various improvements and modifications can be made by those of ordinary skills in the art, without departing from the principle of the present disclosure. Such improvements and modifications shall fall within the protection scope of claims in this application.

It should be noted that the relationship terminologies such as first, second or the like are used herein to distinguish one entity or operation from another, rather than to necessitate or imply an actual relationship or order among the entities or operations. Furthermore, terms “include”, “comprise” or any other variants are intended to cover a non-exclusive inclusion. Therefore, a process, method, article or device including a series of elements is not necessarily limited to those expressly listed elements, but may include other elements not expressly listed or inherent to the process, method, article, or device. Unless expressively limited otherwise, a statement “comprising (including) one . . . ” does not exclude existence of another similar element in the process, method, article or device.

1. A method for audio processing, comprising:
obtaining a target dry audio, and determining a beginning and ending time of each lyric word in the target dry audio;
detecting a pitch of the target dry audio and a fundamental frequency during the beginning and ending time, and determining a current pitch name of the lyric word based on the fundamental frequency and the pitch;
tuning up the lyric word by a first key interval to obtain a first harmony, and tuning up the lyric word by different second key intervals respectively to obtain different second harmonies, wherein
the first key interval indicates a positive integer number of keys,
each of the second key intervals is a sum of the first key interval and a third key interval, and different ones of the second key intervals are determined from different third key intervals, and
the first key interval is different form the third key interval by one order of magnitude;
synthesizing the first harmony and the second harmonies to form a multi-track harmony; and
mixing the multi-track harmony with the target dry audio to obtain a synthesized dry audio.

2. The method according to claim 1, wherein the detecting a pitch of the target dry audio comprises:
extracting an audio feature from the target dry audio, wherein the audio feature comprises a fundamental frequency feature and spectral information; and
inputting the audio feature to a pitch classifier to obtain the pitch of the target dry audio.

3. The method according to claim 1, wherein
the method further comprises
tuning up the target dry audio by the third key intervals respectively to obtain third harmonies; and
the synthesizing the first harmony and the second harmonies to form a multi-track harmony comprises
synthesizing the third harmonies, the first harmony, and the second harmonies to form a multi-track harmony.

4. The method according to claim 3, wherein the synthesizing the third harmonies, the first harmony, and the second harmonies to form a multi-track harmony comprises:
determining volumes and delays of the third harmonies, the first harmony, and the second harmonies, respectively; and
synthesizing the third harmonies, the first harmony, and the second harmonies based on the volumes and delays corresponding to the third harmonies, the first harmony, and the second harmonies, to obtain the multi-track harmony.

5. The method according to claim 1, wherein the method further comprises:
adding a sound effect to the synthesized dry audio by using a sound effect device;
obtaining an accompaniment audio corresponding to the synthesized dry audio, and
superimposing, in a preset manner, the accompaniment audio with the synthesized dry audio added with the sound effect, to obtain a synthesized audio.

6. The method according to claim 5, wherein the superimposing the accompaniment audio with the synthesized dry audio added with the sound effect in a preset manner to obtain a synthesized audio comprises:
performing a power normalization on the accompaniment audio to obtain an intermediate accompaniment audio, and performing a power normalization on the synthesized dry audio added with the sound effect to obtain an intermediate dry audio; and
superimposing, based on a preset energy ratio, the intermediate accompaniment audio with the intermediate dry audio, to obtain the synthesized audio.

7. The method according to claim 1, wherein the tuning up the lyric word by a first key interval to obtain a first harmony, and tuning up the lyric word by different second key intervals respectively to obtain different second harmonies comprises:
determining a preset pitch name interval, and tuning up the lyric word by the preset pitch name interval to obtain the first harmony, wherein adjacent pitch names are different from each other by one or two first key intervals; and
tuning up the first harmony by the third key intervals respectively to obtain the second harmonies.

8. The method according to claim 7, wherein the tuning up the lyric word by the preset pitch name interval to obtain the first harmony comprises:
determining, based on the current pitch name and the preset pitch name interval, a target pitch name of the lyric word after tuned up by the preset pitch name interval;
determining a quantity of the first key intervals corresponding to the lyric word based on a key interval between the target pitch name of the lyric word and the current pitch name of the lyric word; and
tuning up the lyric word by the quantity of the first key intervals to obtain the first harmony.

9. (canceled)

10. An electronic device, comprising:
a memory storing a computer program; and
a processor, wherein
the processor, when executing the computer program, is configured to:
obtain a target dry audio, and determine a beginning and ending time of each lyric word in the target dry audio;
detect a pitch of the target dry audio and a fundamental frequency during the beginning and ending time, and determine a current pitch name of the lyric word based on the fundamental frequency and the pitch;
tune up the lyric word by a first key interval to obtain a first harmony, and tune up the lyric word by different second key intervals respectively to obtain different second harmonies, wherein
the first key interval indicates a positive integer number of keys,
each of the second key intervals is a sum of the first key interval and a third key interval, and different ones of the second key intervals are determined from different third key intervals, and
the first key interval is different form the third key interval by one order of magnitude; and
synthesize the first harmony and the second harmonies to form a multi-track harmony; and mix the multi-track harmony with the target dry audio to obtain a synthesized dry audio.

11. A computer-readable storage medium, wherein
the computer-readable storage medium stores a computer program, and
the computer program, when executed by a processor, is configured to:
obtain a target dry audio, and determine a beginning and ending time of each lyric word in the target dry audio;
detect a pitch of the target dry audio and a fundamental frequency during the beginning and ending time, and determine a current pitch name of the lyric word based on the fundamental frequency and the pitch;
tune up the lyric word by a first key interval to obtain a first harmony, and tune up the lyric word by different second key intervals respectively to obtain different second harmonies, wherein
the first key interval indicates a positive integer number of keys,
each of the second key intervals is a sum of the first key interval and a third key interval, and different ones of the second key intervals are determined from different third key intervals, and
the first key interval is different form the third key interval by one order of magnitude; and
synthesize the first harmony and the second harmonies to form a multi-track harmony; and mix the multi-track harmony with the target dry audio to obtain a synthesized dry audio.

12. The electronic device according to claim 10, further configured to:
extract an audio feature from the target dry audio, wherein the audio feature comprises a fundamental frequency feature and spectral information; and
input the audio feature to a pitch classifier to obtain the pitch of the target dry audio.

13. The electronic device according to claim 10, further configured to:
tune up the target dry audio by the third key intervals respectively to obtain third harmonies, after a current pitch name of the lyric word is determined based on the fundamental frequency and the pitch; and
synthesize the third harmonies, the first harmony, and the second harmonies to form a multi-track harmony.

14. The electronic device according to claim 13, further configured to:
determine volumes and delays of the third harmonies, the first harmony, and the second harmonies, respectively; and
synthesize the third harmonies, the first harmony, and the second harmonies based on the volumes and delays corresponding to the third harmonies, the first harmony, and the second harmonies, to obtain the multi-track harmony.

15. The electronic device according to claim 10, further configured to:
add a sound effect to the synthesized dry audio by using a sound effect device; and
obtain an accompaniment audio corresponding to the synthesized dry audio, and superimpose the accompaniment audio with the synthesized dry audio added with the sound effect in a preset manner to obtain a synthesized audio.

16. The electronic device according to claim 15, further configured to:
perform a power normalization on the accompaniment audio to obtain an intermediate accompaniment audio, and perform a power normalization on the synthesized dry audio added with the sound effect to obtain an intermediate dry audio; and
superimpose, based on a preset energy ratio, the intermediate accompaniment audio with the intermediate dry audio, to obtain the synthesized audio.

17. The electronic device according to claim 10, further configured to:
determine a preset pitch name interval, and tune up the lyric word by the preset pitch name interval to obtain the first harmony, wherein adjacent pitch names are different from each other by one or two first key intervals; and
tune up the first harmony by the third key intervals respectively to obtain the second harmonies.

18. The electronic device according to claim 17, further configured to:
determine, based on the current pitch name and the preset pitch name interval, a target pitch name of the lyric word after tuned up by the preset pitch name interval;
determine a quantity of the first key intervals corresponding to the lyric word based on a key interval between the target pitch name of the lyric word and the current pitch name of the lyric word; and
tune up the lyric word by the quantity of the first key intervals to obtain the first harmony.
